(19) United States
(12) Patent Application Publication
(10) Pub. No.: US 2012/0226621 A1
(43) Pub. Date: Sep. 6, 2012

(54) MODELING RISK OF FOODBORNE ILLNESS OUTBREAKS

(75) Inventors: Ruth L. Petran, Eagan, MN (US); Bruce W. White, Hugo, MN (US)

(73) Assignee: Ecolab USA Inc., St. Paul, MN (US)

(21) Appl. No.: 13/411,362

(22) Filed: Mar. 2, 2012

Related U.S. Application Data
(60) Provisional application No. 61/448,962, filed on Mar. 3, 2011.

(51) Int. Cl. G06Q 99/00

(52) U.S. Cl. 705/317

(57) ABSTRACT

A foodborne illness risk model determines a relationship between health department inspection data and various factors known to contribute to the risk of foodborne illness. The model may identify a comparative risk value for foodborne illness outbreaks for one or more pathogens at a food establishment based on the food establishment's inspection data. The model may also identify a set of indicative violations more likely to be recorded at outbreak restaurants than non-outbreak restaurants. The model may also develop an outbreak profile continuum based on the number of indicative violations. The model may further determine a position on an outbreak profile continuum for a particular food establishment based on the food establishment's inspection data.

This application claims the benefit of U.S. Provisional Application No. 61/448,962, filed Mar. 3, 2011, which is incorporated herein by reference in its entirety.

### TECHNICAL FIELD

The disclosure relates to analysis of foodborne illness outbreaks.

### BACKGROUND

Local, state, and federal health regulations require periodic inspections of restaurants and other food establishments. The inspections are designed to reduce the occurrence of foodborne illness such as norovirus, Salmonella, C. perfringens, E. coli, and others. During these inspections, the restaurants are audited against a variety of criteria related to foodborne illness risk factors and good retail practices. These criteria may include, for example, poor personal hygiene, food from unsafe sources, inadequate cooking, improper (hot and/or cold) holding temperatures, contaminated equipment, etc. There are more than 3,000 health department jurisdictions across the United States alone, and among these are varying standards for how inspections should be conducted.

### SUMMARY

In general, the disclosure is directed to systems and/or methods that analyze health department inspection data with respect to foodborne illness outbreaks.

In one example, the disclosure is directed to a method comprising receiving inspection data from a plurality of restaurants that each experienced at least one associated foodborne illness outbreak, receiving inspection data from a plurality of restaurants that did not experience any foodborne illness outbreaks, mapping the inspection data from the plurality of restaurants that each experienced an associated foodborne illness outbreak to a standardized set of survey questions, mapping the inspection data from the plurality of restaurants that did not experience any foodborne illness outbreaks to the standardized set of survey questions, and identifying a set of one or more indicative violations from among the standardized set of survey questions that were recorded more frequently in the restaurants that experienced at least one associated foodborne illness outbreak than in the restaurants that did not experience any foodborne illness outbreaks. The method may further include identifying a set of one or more indicative violations comprises determining a relative risk for each of the standardized set of survey questions based a failure rate per question for the plurality of restaurants that each experienced at least one associated foodborne illness outbreak by a failure rate per question for the plurality of restaurants that did not experience any foodborne illness outbreaks.

In another example, the disclosure is directed to a system comprising a database that stores inspection data from a plurality of restaurants that each experienced at least one associated foodborne illness outbreak and that stores inspection data from a plurality of restaurants that did not experience any foodborne illness outbreaks, a mapping that relates the inspection data from the plurality of restaurants that each experienced an associated foodborne illness outbreak to a standardized set of survey questions and that relates the inspection data from the plurality of restaurants that did not experience any foodborne illness outbreaks to the standardized set of survey questions, and at least one processor that identifies a set of one or more indicative violations from among the standardized set of survey questions that were recorded more frequently in the restaurants that experienced at least one associated foodborne illness outbreak than in the restaurants that did not experience any foodborne illness outbreaks. The processor may further determine a relative risk for each of the standardized set of survey questions based a failure rate per question for the plurality of restaurants that each experienced at least one associated foodborne illness outbreak by a failure rate per question for the plurality of restaurants that did not experience any foodborne illness outbreaks.

The details of one or more examples are set forth in the accompanying drawings and the description below. Other features and advantages will be apparent from the description and drawings, and from the claims.

### BRIEF DESCRIPTION OF DRAWINGS

FIG. 1 is a block diagram illustrating an example environment in which modeling of heightened risk of foodborne illness may be practiced.

FIG. 2 is a flowchart illustrating an example process by which the foodborne illness risk assessment system may determine a generalized risk value for one or more pathogens.

FIG. 3 is a flowchart illustrating an example process for determination of a proportion of foodborne illness outbreaks related to a given contributing factor.

FIG. 4 is a flowchart illustrating an example process for generating a risk matrix for a particular pathogen.

FIG. 5 is a flowchart illustrating an example process of calculating a risk value for a particular pathogen.

FIG. 6 is a flowchart illustrating an example process for calculating a risk assessment for an individual jurisdictional inspection survey.

FIGS. 7A and 7B show an example question/contributing factor matrix for three pathogens, norovirus, Salmonella and C. perfringens.

FIGS. 8A and 8B are graphs illustrating the distribution of the percent of restaurant locations having a given number of indicative violation failures.

FIG. 9 is a flowchart illustrating an example process by which a set of one or more indicative violations may be determined.

FIG. 10 is a flowchart illustrating an example process by which an outbreak profile continuum may be generated.

FIG. 11 is a flowchart illustrating an example process by which a restaurant's position on an outbreak profile continuum may be determined.

### DETAILED DESCRIPTION

In general, the disclosure is directed to systems and/or methods that analyze health department inspection data and various factors known to contribute to the risk of foodborne illness. In some examples, the systems and/or methods may identify a comparative risk of a foodborne illness outbreak at a particular food establishment based on the food establishment's inspection data and on health department inspection data from other food establishments. In other examples, the systems and/or methods may develop a “profile” of an outbreak restaurant by identifying a set of indicative violations more likely to be recorded at outbreak restaurants than non-outbreak restaurants.

In general foodborne illnesses may include any illness resulting from the consumption of contaminated food, pathogenic bacteria, viruses, or parasites that contaminate food. Common causes of foodborne illness include norovirus, Salmonella, Campylobacteri, C. perfringens, E. coli, and many others. Although specific examples will be described herein with respect to norovirus, Salmonella, and C. perfringens, it shall be understood that the foodborne illness risk modeling techniques described herein may also be applied to other causes and types of foodborne illness outbreaks.

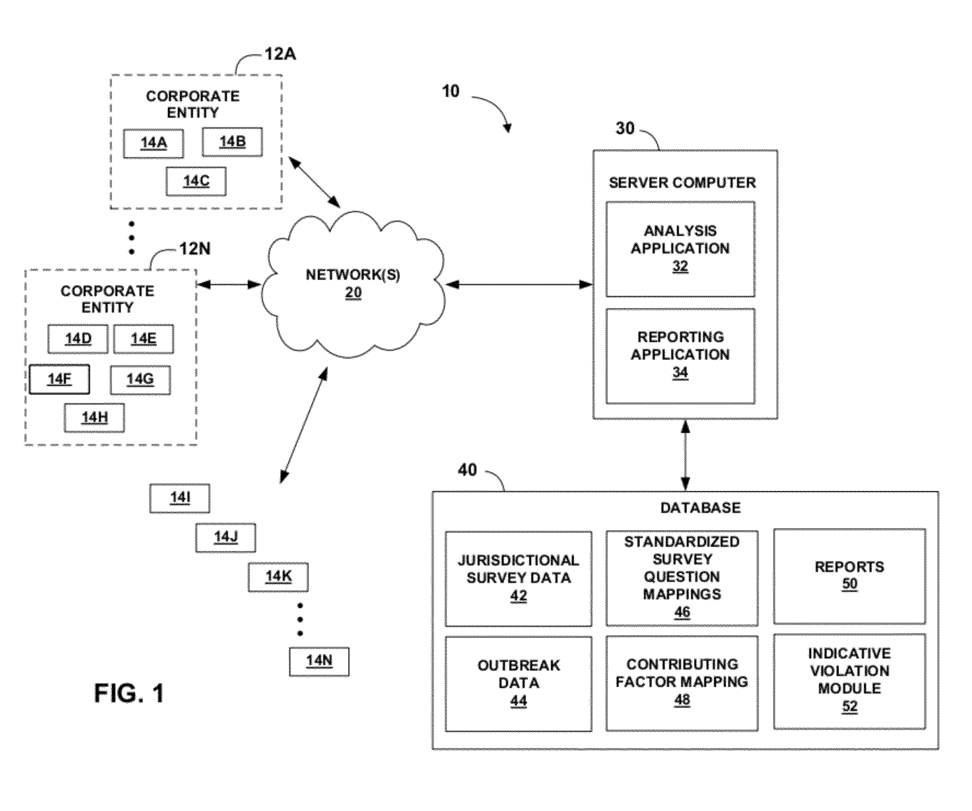

A FIG. 1 is a block diagram illustrating an example environment in which modeling of risk of foodborne illness outbreaks may be practiced. A plurality of food establishments 14A-14N may be located in various cities or states across the country. Food establishments 14A-14N may include restaurants, food preparation or packaging entities, caterers, food transportation vehicles, food banks, etc., and will be generally referred to herein as “restaurants.” Some of the restaurants 14A-14N may be owned, operated, or otherwise associated with one or more corporate entities 12A-12N. In FIG. 1, for example, restaurants 14A-14C are associated with corporate entity 12A and restaurants 14D-14H are associated with corporate entity 12N. Some of the restaurants may be stand alone or individually owned restaurants, such as restaurants 14I-14N. Although in the present disclosure food establishments 14A-14N will be generally referred to as “restaurants,” it shall be understood that food establishments 14A-14N may include any establishment that that stores, prepares, packages, serves, or sells food for human consumption. The food establishments may also include other food related locations or businesses that are inspected, such as food producers, food processing facilities, food packaging plants, etc.

State and local public health departments typically require food establishments to be periodically inspected for compliance with agency standards. The frequency of these inspections varies by jurisdiction but routine inspections may be required annually, biannually, or at some other periodic interval. Follow-up or investigative inspections may also be required in the event one or more of the standards are not met. At each inspection, an inspection report is prepared which indicates compliance with a variety of foodborne illness risk factors. The format and focus of these inspection reports may also vary by jurisdiction.

A server computer 30 provides reports regarding risk of foodborne illness outbreaks based in part on health inspection surveys conducted at each restaurant 14A-14N. Such reports may be communicated electronically to corporate entities 12A-12N and/or restaurants 14A-14N via one or more network(s) 20. Network(s) 20 may include, for example, one or more of a dial-up connection, a local area network (LAN), a wide area network (WAN), the internet, a cell phone network, satellite communication, or other means of electronic communication. The reports may also be communicated via hard copy and then entered into electronic form. The communication may be wired or wireless. Server computer 30 may also, at various times, send commands, instructions, software updates, etc. to one or more corporate entities 12A-12N and/or restaurants 14A-14N via network(s) 20. Server computer 30 may receive data or otherwise communicate with corporate entity 12A-12N and/or restaurant 14A-14N on a periodic basis, in real-time, upon request of server computer 30, upon request of one or more of corporate entities 12A-12N and/or restaurants 14A-14N or at any other appropriate time.

Server computer 30 includes a database 40 or other storage media that stores the various data and programming modules required to model risks of foodborne illness outbreaks. Database 40 may store, for example, health inspection survey data 42 regarding state and local inspections of each of the restaurants 14A-14N; outbreak data 44 regarding actual foodborne illness outbreaks; standardized survey question mappings 46; a contributing factor mapping 48; a variety of reports 50, and/or an indicative violation module 52.

Jurisdictional survey data 42 may include inspection data obtained at the state or local level during routine or follow-up inspections of restaurants 14A-14N. The individual inspection surveys stored in survey data 42 may be received directly from state and/or local health departments, from each restaurant or corporate entity, from a 3^{rd} party, may be obtained online, or may be received in any other manner. Survey data 42 for each individual inspection survey may include, for example, restaurant identification information, state or local agency information, inspection report information including information concerning compliance with the relevant food safety standards, inspection report date and time stamps, and/or any other additional information gathered or obtained during an inspection.

Outbreak data 44 data may include data obtained during investigations of actual foodborne illness outbreaks. For example, the Centers for Disease Control and Prevention (CDC) assembles data from states and periodically reports data on the occurrence of foodborne disease outbreaks (defined as the occurrence of two or more cases of a similar illness resulting from the ingestion of a common food) in the United States. These reports may include data on factors that are suggested to have contributed to certain foodborne illness outbreaks. These so-called “contributing factors” are grouped into three types: those believed to lead to contamination of the food (contamination factors); those that allow proliferation of the pathogen in the food (proliferation factors); and those that contribute to survival of the pathogen in the food (survival factors). The reports may also include data on the date(s) and location(s) of the foodborne illness outbreak, and number of people affected by the foodborne illness outbreak, the pathogen associated with the outbreak, the symptoms experienced by those affected by the outbreak, a breakdown by age and gender of those affected by the outbreak, the food or foods implicated in the outbreak, and other data associated with the outbreak. Outbreak data 44 may include data from these and/or other reports obtained during investigations of foodborne illness outbreaks.

Standardized survey question mappings 46 relate the data obtained from state and local jurisdictional inspection reports to a standardized set of inspection survey questions. In some examples, the standardized set of survey questions is a set of 54 questions related to foodborne illness risk factors and good retail practices provided by The United States Food and Drug Administration (FDA) in model form 3-A. The 54 questions are presented in a model “Food Establishment Inspection Report” intended to provide a model for state and local agencies to follow when conducting inspections of food establishments. However, the adoption of the model form by state and local jurisdictions varies, therefore a wide variety of reporting procedures may be found across the United States. Standardized survey question mappings 46 may relate individual jurisdictional inspection surveys to this 54 question set or to another standardized set of survey questions so that inspections from multiple jurisdictions may be compared and contrasted using the same system of measurement. Contributing factor mapping 48 relates the CDC contributing factors to the standardized set of survey questions.

An indicative violation module 52 includes instructions for identifying a set of one or more indicative violations that are recorded more frequently in outbreak location than in non-outbreak locations. Indicative violation module 52 may also include instructions for determining the percentage of outbreak and non-outbreak locations experiencing a given number of indicative violations, for generating one or more outbreak profile continuums, and/or for determining a position on an outbreak profile continuum for a particular restaurant based on that restaurant's inspection data.

Server computer 30 includes an analysis application 32 that analyzes the survey data 42 for each restaurant 14A-14N. A reporting application 34 generates a variety of reports that present the analyzed data for use by the person(s) responsible for overseeing inspection compliance at each restaurant 14A-14N. Reporting application 34 may generate a variety of reports 50 to provide users at the corporate entities 12A-12N or users at individual restaurants 14A-14N with foodborne illness risk information regarding their associated restaurants. The reports may also compare foodborne illness risk data over time to identify trends or to determine whether improvement has occurred. Reporting application 34 may also allow users to benchmark foodborne illness risk compliance at multiple restaurants or food establishments. One or more of the reports 50 may be downloaded and stored locally at the corporate entity or individual restaurant, on an authorized user's personal computing device, on another authorized computing device, printed out in hard copy, or further communicated to others as desired.

In some examples, computing device(s) at one or more of the corporate entities 12A-12N or individual restaurants 14A-14N may include the capability to provide the analysis and reporting functions described above with respect to server computer 30. In these examples, computing device(s) associated with the corporate entity or individual restaurant may also store the above-described survey data associated with the corporate entity or individual restaurant. The computing device(s) may also include local analysis and reporting applications such as those described above with respect to analysis and reporting applications 32 and 34. In that case, reports associated with that particular corporate entity and/or individual restaurant may be generated and viewed locally, if desired. In another example, all analysis and reporting functions are carried out remotely at server computer 30, and reports may be viewed, downloaded, or otherwise obtained remotely. In other examples, certain of the corporate entities/individual restaurants may include local storage and/or analysis and reporting functions while other corporate entities/individual restaurants rely on remote storage and/or analysis and reporting. Thus, it shall be understood that the storage, analysis, and reporting functions may be carried out either remotely at a central location, locally, or at some other location, and that the disclosure is not limited in this respect.

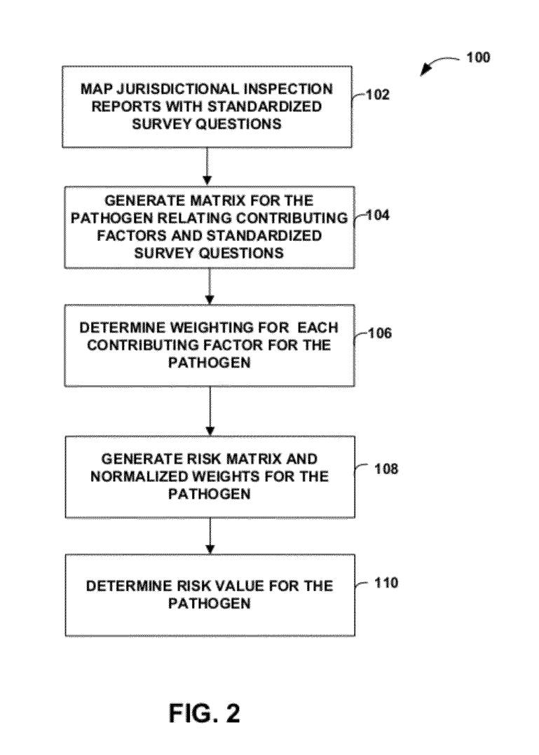

FIG. 2 is a flowchart illustrating an example process by a system for modeling risk of foodborne illness outbreaks that may determine a generalized risk value for one or more pathogens (100). As mentioned above, the CDC collects and periodically reports data on the occurrence of foodborne disease outbreaks in the United States. These reports may include data on factors that are believed to have contributed to each foodborne illness outbreaks. These so-called “contributing factors” are grouped into three types: those believed to lead to contamination of the food (contamination factors); those that allow proliferation of the pathogen in the food (proliferation factors); and those that contribute to survival of the pathogen in the food (survival factors). A list of these contributing factors may be found at “Surveillance for Foodborne-Disease Outbreaks—United States 1998-2002,” Morbidity and Mortality Weekly Report, vol. 55, No. SS-10, Nov. 10, 2006, or at http://www.cdc.gov/MMWR/preview/mmwrhtml/ss5510a1.htm. A list of the contributing factors from this publication and their definitions is reproduced below.

### **Contributing Factor Definitions:

### Contamination Factors:

C1—Toxic substance part of tissue (e.g., ciguatera)
C2—Poisonous substance intentionally added (e.g., cyanide or phenolphthalein added to cause illness)
C3—Poisonous or physical substance accidentally/incidentally added (e.g., sanitizer or cleaning compound)
C4—Addition of excessive quantities of ingredients that are toxic under these situations (e.g., niacin poisoning in bread)
C5—Toxic container or pipelines (e.g., galvanized containers with acid food, copper pipe with carbonated beverages)
C6—Raw product/ingredient contaminated by pathogens from animal or environment (e.g., Salmonella enteriditis in egg, Norwalk in shellfish, E. coli in sprouts)
C7—Ingestion of contaminated raw products (e.g., raw shellfish, produce, eggs)
C8—Obtaining foods from polluted sources (e.g., shellfish)
C9—Cross-contamination from raw ingredient of animal origin (e.g., raw poultry on the cutting board)
C10—Bare-handed contact by handler/worker/preparer (e.g., with ready-to-eat food)
C11—Glove-handed contact by handler/worker/preparer (e.g., with ready-to-eat food)
C12—Handling by an infected person or carrier of pathogen (e.g., Staphylococcus spp., Salmonella spp., Norwalk agent)
C13—Inadequate cleaning of processing/preparation equipment/utensils—leads to contamination of vehicle (e.g., cutting boards)
C14—Storage in contaminated environment—leads to contamination of vehicle (e.g., store room, refrigerator)
C15—Other source of contamination (please describe in Comments)

### Proliferation Factors:

P1—Allowing foods to remain at room or warm outdoor temperature for several hours (e.g., during preparation or holding for service)
P2—Slow cooling (e.g., deep containers or large roasts)
P3—Inadequate cold-holding temperatures (e.g., refrigerator inadequate/not working, iced holding inadequate)
P4—Preparing foods a half day or more before serving (e.g., banquet preparation a day in advance)
P5—Prolonged cold storage for several weeks (e.g., permits slow growth of psychrophilic pathogens)
P6—Insufficient time and/or temperature during hot holding (e.g., malfunctioning equipment, too large a mass of food)
P7—Insufficient acidification (e.g., home canned foods)
P8—Insufficiently low water activity (e.g., smoked/salted fish)
P9—Inadequate thawing of frozen products (e.g., room thawing)
P10—Anaerobic packaging/Modified atmosphere (e.g., vacuum packed fish, salad in gas flushed bag)
P11—Inadequate fermentation (e.g., processed meat, cheese)
P12—Other situations that promote or allow microbial growth or toxic production (please describe in Comments)

### Survival Factors:

S1—Insufficient time and/or temperature during initial cooking/heat processing (e.g., roasted meats/poultry, canned foods, pasteurization)
S2—Insufficient time and/or temperature during reheating (e.g., sauces, roasts)
S3—Inadequate acidification (e.g., mayonnaise, tomatoes canned)
S4—Insufficient thawing, followed by insufficient cooking (e.g., frozen turkey)
S5—Other process failures that permit the agent to survive (please describe in Comments)

Referring again to FIG. 2, the model maps the jurisdictional inspection reports from a plurality of different jurisdictions to the standardized set of survey questions (102). These mappings may be stored, for example, as standardized survey question mappings 46. In one example, the standardized set of survey questions includes the 54 questions presented in the FDA model Food Establishment Inspection Report Form 3-A. The model Food Inspection Report may be found at FDA Food Code 2009: Annex 7—Model Forms, Guides and Other Aids, or at http://www.fda.gov/Food/FoodSafety/RetailFoodProtection/FoodCode/FoodCode2009/ucm188327.htm#form3a. A list of the 54 questions from the FDA model report is reproduced below.

### FDA Food Code Form 3a

### Supervision

Q1 Person in charge present, demonstrates knowledge, and performs duties

### Employee Health

Q2 Management, food employee and conditional employee; knowledge, responsibilities and reporting
Q3 Proper use of restriction and exclusion

### Good Hygienic Practices

Q4 Proper eating, tasting, drinking, or tobacco use
Q5 No discharge from eyes, nose, and mouth

### Control of Hands as a Vehicle of Contamination

Q6 Hands clean & properly washed
Q7 No bare hand contact with RTE food or a pre-approved alternative procedure properly allowed
Q8 Adequate handwashing sinks properly supplied and accessible

### Approved Source

Q9 Food obtained from approved source
Q10 Food received at proper temperature
Q11 Food in good condition, safe, & unadulterated
Q12 Required records available: shellstock tags, parasite destruction
   Protection from Contamination
Q13 Food separated & protected
Q14 Food-contact surfaces: cleaned & sanitized
Q15 Proper disposition of returned, previously served, reconditioned, & unsafe food

### Potentially Hazardous Food Time/Temperature

Q16 Proper cooking time & temperatures
Q17 Proper reheating procedures for hot holding
Q18 Proper cooling time & temperatures
Q19 Proper hot holding temperatures
Q20 Proper cold holding temperatures
Q21 Proper date marking & disposition
Q22 Time as a public health control: procedures & records

### Consumer Advisory

Q23 Consumer advisory provided for raw or undercooked foods

### Highly Susceptible Populations

Q24 Pasteurized foods used; prohibited foods not offered

### Chemical

Q25 Food additives: approved & properly used
Q26 Toxic substances properly identified, stored, & used
   Conformance with Approved Procedures
Q27 Compliance with variance, specialized process, & HACCP plan

### Safe Food and Water

Q28 Pasteurized eggs used where required
Q29 Water & ice from approved source
Q30 Variance obtained for specialized processing methods

### Food Temperature Control

Q31 Proper cooling methods used; adequate equipment for temperature control
Q32 Plant food properly cooked for hot holding
Q33 Approved thawing methods used
Q34 Thermometers provided & accurate

### Food Identification

Q35 Food properly labeled; original container

### Prevention of Food Contamination

Q36 Insects, rodents, & animals not present
Q37 Contamination prevented during food preparation, storage & display
Q38 Personal cleanliness
Q39 Wiping cloths: properly used & stored
Q40 Washing fruits & vegetables

### Proper Use of Utensils

Q41 In-use utensils: properly stored
Q42 Utensils, equipment & linens: properly stored, dried, & handled
Q43 Single-use/single-service articles: properly stored & used
Q44 Gloves used properly

### Utensils, Equipment and Vending

Q45 Food & non-food contact surfaces cleanable, properly designed, constructed, & used
Q46 Warewashing facilities: installed, maintained, & used; test strips
Q47 Non-food contact surfaces clean

### Physical Facilities

Q48 Hot & cold water available; adequate pressure
Q49 Plumbing installed; proper backflow devices
Q50 Sewage & waste water properly disposed
Q51 Toilet facilities: properly constructed, supplied, & cleaned
Q52 Garbage & refuse properly disposed; facilities maintained
Q53 Physical facilities installed, maintained, & clean
Q54 Adequate ventilation & lighting; designated areas used

The model also includes a matrix for each pathogen that relates each of the contributing factors and the standardized survey questions (104). These mappings may be stored, for example, as contributing factor mappings 46. The matrix may be thought of as having the standardized survey questions as row labels and the contributing factors as column labels. Contributing factors may then be related to the standardized survey questions in this matrix based on the likelihood of their being related to risks of each pathogen under consideration, such as norovirus, Salmonella, and C. perfringens, by placing an “N” (norovirus), “S” (Salmonella), and/or “C” (C. perfringens) in the intersecting cell. For example, Table 2 shows a portion of an example relationship matrix for the pathogens norovirus, Salmonella, and C. perfringens. The contributing factors are indicated as being related to-the standardized survey questions by placing an “N” (norovirus), “S” (Salmonella), and/or “C” (C. perfringens) in the intersecting cell. If a cell has more than one letter, the corresponding question and contributing factor relate to more than one pathogen.

TABLE 1

| Question # | c12 | p1 | s1 |
|---|---|---|---|
| Q06 | NS | | |
| Q10 | | CS | |
| Q16 | | | CS |
| Q23 | | | NS |
| Q24 | | | S |
| Q25 | | | |

In this example, contributing factor c12 is related to question Q06 for both norovirus and Salmonella outbreaks, factor p1 is related to Q10 for both Salmonella and C. perfringens outbreaks, factor s1 is related to Q16 for both Salmonella and C. perfringens outbreaks, factor s1 is related to Q23 for both norovirus and Salmonella outbreaks, and factor s1 is related to Q24 for Salmonella outbreaks.

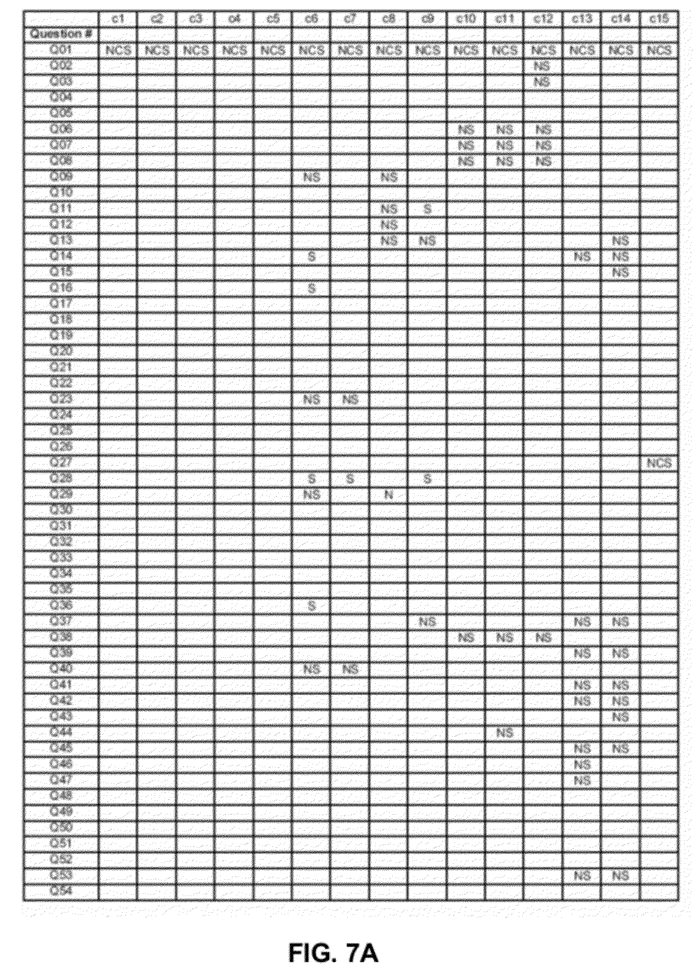

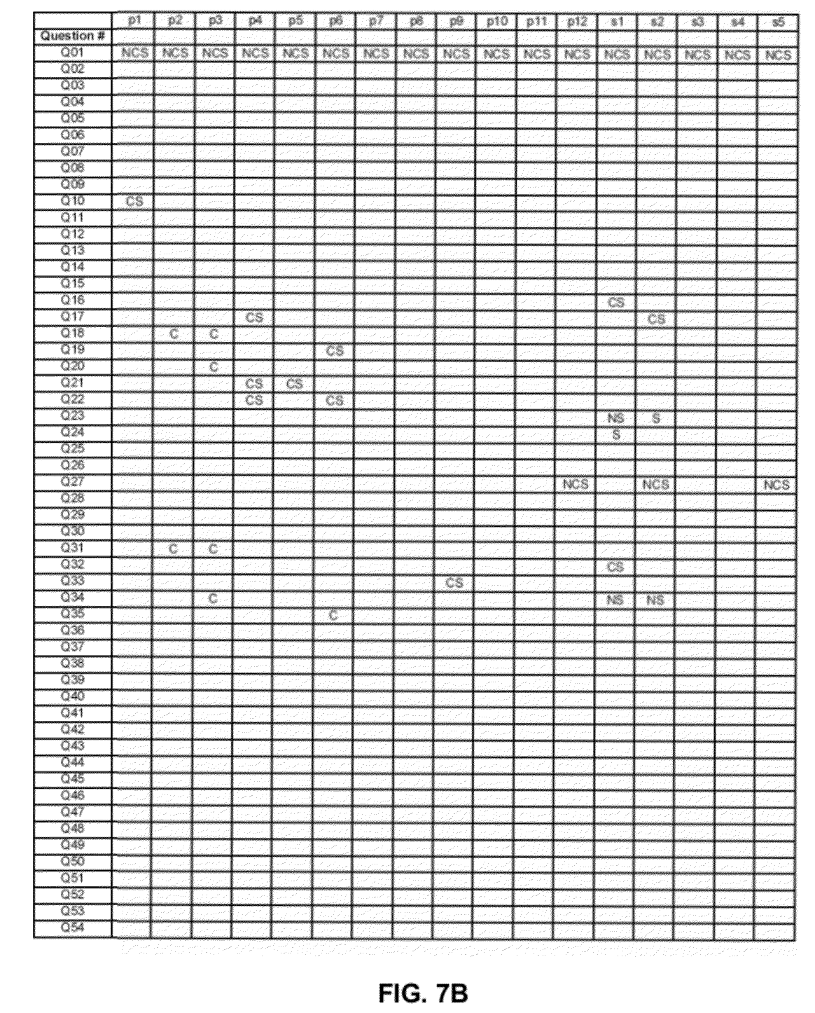

FIGS. 7A and 7B show an example question/contributing factor matrix for three pathogens, norovirus, Salmonella and C. perfringens.

Referring again to FIG. 2, for each pathogen under consideration, the foodborne illness outbreak model determines a weighting for each of the above-listed contributing factors (106). For example, Table 2 illustrates how the weighting for three of the factors may be determined for pathogens norovirus, Salmonella, and C. perfringens.

TABLE 2

| | | # of | proportion of | # of | proportion of | # of | proportion of |
|---|---|---|---|---|---|---|---|
| | | confirmed | confirmed | confirmed | confirmed | confirmed | confirmed |
| | Contributing | norovirus | norovirus | Salmonella | Salmonella | C. perf | C. perf |
| Label | factor | outbreaks | outbreaks | outbreaks | outbreaks | outbreaks | outbreaks |
| c12 | Infected | 202 | 0.6332 | 64 | 0.1963 | 2 | 0.0196 |
| | worker | | | | | | |
| p01 | Room temp | 17 | 0.0533 | 110 | 0.3374 | 53 | 0.5196 |
| | several hours | | | | | | |
| s01 | Insufficient | 5 | 0.0157 | 104 | 0.3190 | 33 | 0.3235 |
| | time/temp | | | | | | |
| | during cooking | | | | | | |

Column 2 of Table 2 lists the contributing factors related foodborne disease outbreaks as defined by US 1998-2002 (Extrapolated from Table 19, CDC 2006. MMWR 55 (SS10): 1-34.). Column 3 gives the number of confirmed norovirus outbreaks for which the given factor was believed to have contributed. Column 4 gives the proportion of confirmed norovirus outbreaks related to the given factor. Column 5 gives the number of confirmed Salmonella outbreaks for which the given factor was believed to have contributed. Column 6 gives the proportion of confirmed Salmonella outbreaks related to the given factor. Column 7 gives the number of confirmed C. perfringens outbreaks for which the given factor was believed to have contributed. Column 8 gives the proportion of confirmed C. perfringens outbreaks related to the given factor.

In this example, there were 319 confirmed norovirus outbreaks during the 1998-2002 timeframe. Factor c12 contributed to 202 of those outbreaks, factor p1 contributed to 17, and factor s1 contributed to 5. Dividing each of these numbers by 319 (the total number of outbreaks for the pathogen) gives the weights shown in column four of Table 2. The values of the weights in column four for all 32 factors may add up to more than 1 due to the fact that one outbreak can have multiple contributing factors. Similar calculations were carried out for Salmonella and C. perfringens.

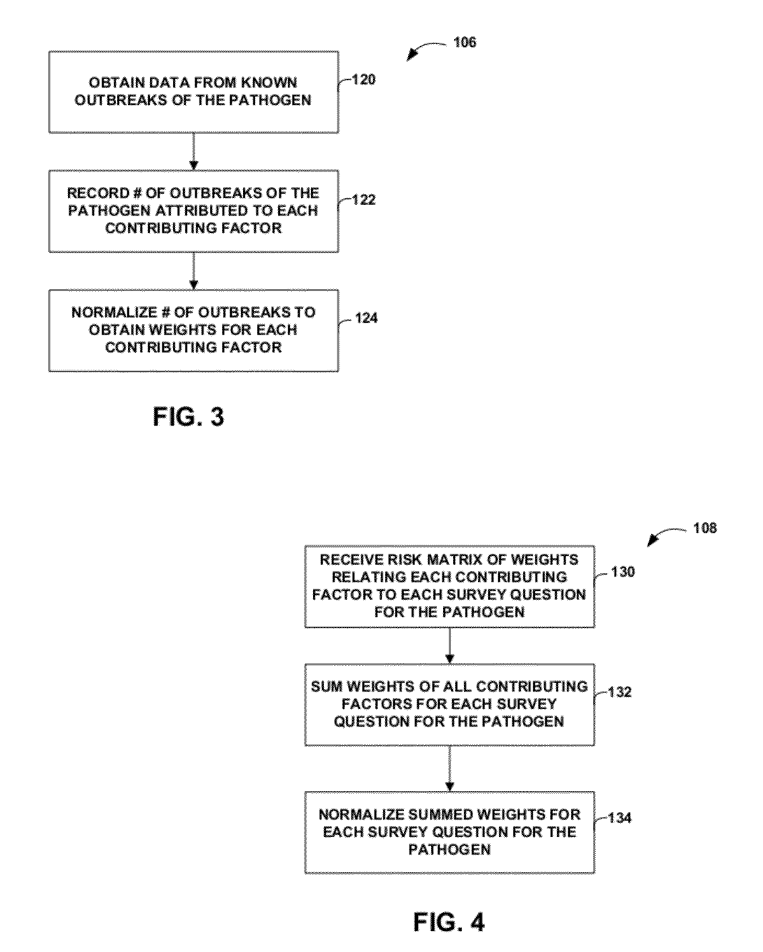

FIG. 3 is a flowchart illustrating a more detailed example process by which the weights for each pathogen may be determined (106). The model obtains the data from known outbreaks of the pathogen. This may be stored as, for example, outbreak data 44 in FIG. 1. From this data, the model obtains the number of outbreaks of the pathogen that were attributed to each contributing factor (122). This information is also available from the data obtained from known outbreaks of the pathogen. This data may then be normalized (124) to determine a proportion of confirmed pathogen outbreaks related to the given factor. Examples of these normalized weights are shown in Table 2, column 4 (norovirus), column 6 (Salmonella), and column 8 (C. perfringens).

Referring again to FIG. 2, the model also generates a risk matrix for each pathogen under consideration (108). FIG. 4 is a flowchart illustrating an example process for generating a risk matrix for a particular pathogen (108). The model creates a risk matrix for each pathogen using the weights determined as described above with respect to the example of Table 1 (130). An example risk matrix is shown in FIGS. 7A and 7B. Again the matrix may be thought of as a matrix having rows labeled with the standardized survey questions and columns labeled with the contributing factors. The model then sums the weights of all contributing factors for each standardized survey question (132). The model may then normalize the summed weights for each standardized survey question (134).

Table 3 shows a part of an example Salmonella risk matrix. The value of 0.1963 in the intersection of Q06 and c12, for example, comes from the 5^{th} column of Table 2 as the weight for c12 relative to Salmonella outbreaks. Table 3 shows only a subset of the questions for illustrative purposes.

TABLE 3
Salmonella

| | | | | Total | Normalized |
|---|---|---|---|---|---|
| Question # | c12 | p1 | s1 | Weights | Weights |
| Q06 | 0.1963 | 0 | 0 | 0.322086 | 0.028634 |
| Q10 | 0 | 0.3374 | 0 | 0.337423 | 0.029997 |
| Q16 | 0 | 0 | 0.319 | 0.616564 | 0.054813 |
| Q23 | 0 | 0 | 0.319 | 0.815951 | 0.072539 |
| Q24 | 0 | 0 | 0.319 | 0.319018 | 0.028361 |
| Q25 | 0 | 0 | 0 | 0 | 0 |
| . . . | | | | | |
| Sum for All | | | | 11.24847 | |
| Questions | | | | | |

The column labeled “Total Weights” in Table 3 is the sum of all the individual weights of the contributing factors that relate to the given question. For example, 0.322086 is the total of all the contributing factor weights that relate Q06 to the risk of a Salmonella outbreak. The value in the row labeled “Sum for All Questions” (11.24 in this example) of Table 3 sums up all the weights for each question. That value is used as the divisor for the last column to come up with normalized weights.

Table 4 shows examples of the normalized weights for some of the standardized survey questions for three pathogens, norovirus, Salmonella, and C. perfringens. Table 4 shows only a subset of the questions for illustrative purposes.

TABLE 4

| | Normalized | Normalized | Normalized |
|---|---|---|---|
| | Weights | Weights | Weights |
| Question # | norovirus | Salmonella | C. perfringens |
| Q06 | 0.143368 | 0.028634 | 0 |
| Q10 | 0 | 0.029997 | 0.087894 |
| Q16 | 0 | 0.054813 | 0.054726 |
| Q23 | 0.017474 | 0.072539 | 0 |
| Q24 | 0 | 0.028361 | 0 |
| Q25 | 0 | 0 | 0 |

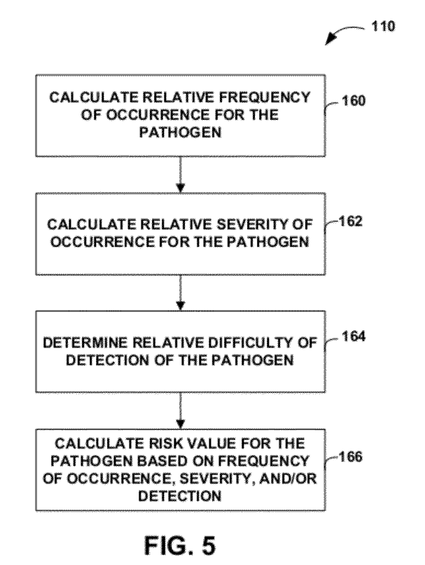

Referring again to FIG. 2, the model determines a risk value for each pathogen under consideration (110). The risk value is based in part upon data obtained from known outbreaks of the pathogen. FIG. 5 illustrates an example process (110) by which the risk value for a particular pathogen may be determined. In this example, the model may calculate a frequency of occurrence for the pathogen (160), a severity of occurrence for the pathogen (162) and/or determine a difficulty of detection of the pathogen (164).

In this example, the model applies a methodology similar to Failure Mode and Effects Analysis (FMEA) by determining frequency of occurrence, severity of occurrence, and/or difficulty of detection. The FMEA ratings for these three categories are such that lower numbers are indicative of a relatively lesser risk of foodborne illness and higher numbers are indicative of a relatively greater risk of foodborne illness.

Frequency of occurrence may be determined or estimated using data from CDC by dividing the number of outbreaks for the pathogen at issue by the total number of outbreaks of all pathogens under consideration. Severity of occurrence may be determined or estimated, for example, based on the death rate attributed to each outbreak, the total number of persons affected by the outbreak, the number of hospitalization attributed to the outbreak, etc.

The difficulty of detection may also be determined or estimated based on known outbreak data. The CDC has estimated that the rates of under-reporting for Salmonella and C. perfringens are approximately equal. Currently, the CDC uses the figure of 29.3 as the under diagnosis multiplier.

The CDC has not published under-diagnosis multipliers for norovirus due to the lack of widespread use of diagnostic tests to confirm infections. Although norovirus infections are 100 times more common than Salmonella, researchers have suggested that norovirus is under reported more frequently than Salmonella. This may be because many people who get norovirus do not become seriously ill and therefore do not seek medical attention. For purposes of this example, the model assumes that Salmonella and C. perfringens have about the same difficulty of detection and that norovirus is about twice as difficult to detect as Salmonella and C. perfringens.

Table 5 gives example values for frequency of occurrence, severity of occurrence, and likelihood of detection.

TABLE 5
Frequency of Occurrence

| | Total | Relative Frequency |
|---|---|---|
| | Outbreaks | of Occurrence |
| norovirus | 1976 | 0.5484 |
| Salmonella | 1361 | 0.3777 |
| C. perfringens | 266 | 0.0738 |

Severity of Occurrence

| | Mortality Rates | |
|---|---|---|
| | (%) | Relative Severity |
| norovirus | 0.007% | 0.0405 |
| Salmonella | 0.135% | 0.7575 |
| C. perfringens | 0.036% | 0.2020 |

Likelihood of Detection

| | Relative | |
|---|---|---|
| | Likelihood of | |
| | Detection | |
| norovirus | 0.4 | These detection values were based on |
| Salmonella | 0.2 | various information from CDC that |
| C. perfringens | 0.2 | seemed to indicate the likelihood of |
| | | detection of an outbreak of Salmonella |
| | | and C. perfringens was about the same |
| | | and that norovirus was at least twice as |
| | | difficult to detect as either of the other |
| | | two pathogens. |

As shown in FIG. 5, the model may calculate a risk value for each pathogen based on the frequency of occurrence, the severity of occurrence, and/or the likelihood of detection. Table 6 shows an example in which the risk value is based on the frequency of occurrence, the severity of occurrence, and the likelihood of detection. However, it shall be understood that the risk value for each pathogen may be determined based on one or more of these factors, or that the risk value for one pathogen may be based on a different combination of factors than the risk value for one or more of the other pathogens. In addition, the risk values for each factor may be presented individually or be based on the request of the corporate entity or individual restaurant, depending upon what they believe to be most relevant to their business.

TABLE 6

| | | | Difficulty | Product | |
|---|---|---|---|---|---|
| | Frequency of | Severity of | of | (O * | Normal- |
| | Occurrence | Occurrence | Detection | S * D) | ized |
| norovirus | 0.5484 | 0.0405 | 0.4 | 0.00889 | 0.1286 |
| Salmonella | 0.3777 | 0.7575 | 0.2 | 0.05723 | 0.8282 |
| C. | 0.0738 | 0.2020 | 0.2 | 0.00298 | 0.0432 |
| perfringens | | | | | |

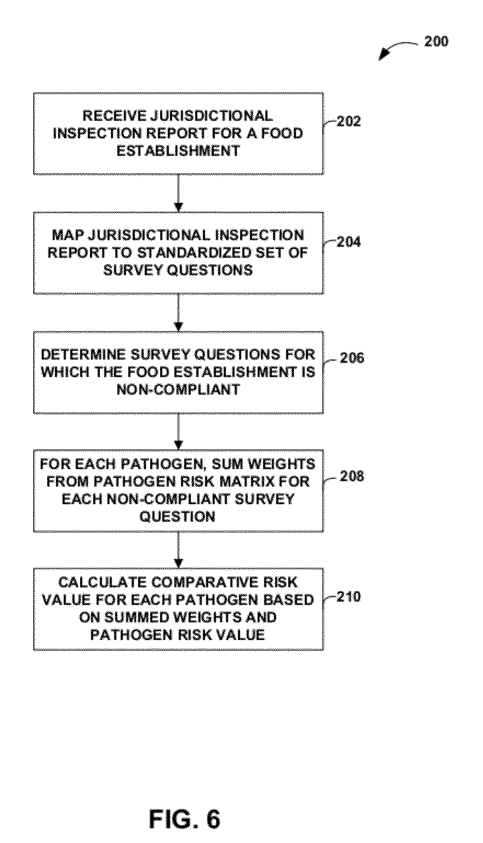

FIG. 6 is a flowchart illustrating an example process 200 by which individual jurisdictional inspection reports may be analyzed and a risk assessment based each of those reports may be determined. In general, process 200 looks at individual jurisdictional inspection reports received by the model and assigns a risk assessment for each of one or more foodborne illness pathogens. These pathogens may include, for example, norovirus, Salmonella, C. perfringens, E. coli, and any other pathogen associated with foodborne illness.

Process 200 may begin when a jurisdictional inspection report for a particular food establishment is received (202). The jurisdictional inspection report is mapped to the standardized survey questions using a mapping such as standardized survey question mapping 46 in FIG. 1 (204).

The model next reviews the now standardized inspection survey to determine for which, if any, of the standardized survey questions the food establishment was found to be non-compliant (206). For each non-compliant survey question, the model may sum the weights from the pathogen risk matrix of each non-compliant survey question (208). If more than one pathogen is being considered, the weights may be summed for each type of pathogen.

For example, Table 7 shows example data from 3 separate inspection surveys taken at a single restaurant. The normalized weights from the pathogen risk matrix (see, e.g., the example normalized weights for each pathogen in Table 4) for each question for which the restaurant was non-compliant were added up and the sum for each pathogen is shown in the Table 7. For example, the sum of weights for each non-compliant question for norovirus in Survey 1 was 0.3554, the sum for non-compliant questions in Survey 2 was 0.5318, and the sum for non-compliant questions in Survey 3 was 0.3225. Example sums for non-compliant survey questions for Salmonella and C. perfringens are also shown in Table 7.

TABLE 7

| Survey | Norovirus | Salmonella | C. perfringens |
|---|---|---|---|
| 1 | 0.3554 | 0.1688 | 0.1161 |
| 2 | 0.5318 | 0.2945 | 0.0000 |
| 3 | 0.3225 | 0.0905 | 0.1161 |

Referring again to FIG. 6, the model calculates a comparative risk value for each pathogen under consideration based on the summed weights for each non-compliant survey question and the pathogen risk value (210). For example, the summed weights for each pathogen (see, e.g., the columns in Table 7) may be multiplied by the normalized pathogen risk values (see, e.g., the last column of table 6) to provide the weights for the 3 survey examples for each of the pathogens. Example values for the comparative risk values for each of the three pathogens are shown in Table 8.

TABLE 8

| Survey | Norovirus | Salmonella | C. perfringens |
|---|---|---|---|
| 1 | 0.0457 | 0.1398 | 0.0050 |
| 2 | 0.0684 | 0.2439 | 0.0000 |
| 3 | 0.0415 | 0.0750 | 0.0050 |

The comparative risk values shown and described above illustrate the comparative risk of a foodborne illness outbreak for one survey relative to another survey. In these examples the comparative risk value is not an absolute value or probability of a foodborne illness outbreak, but rather illustrates a comparative risk when measured against other surveys. For example, the comparative risk for norovirus found with respect to Survey 1 is greater than the comparative risk for norovirus found with respect to Survey 3, but less than the comparative risk for norovirus found with respect to Survey 2. The comparative risk for C. perfringens found with respect to Survey 1 is about the same as the comparative risk found with respect to Survey 3, and the comparative risk found with respect to both Survey 1 and Survey 3 are greater than the comparative risk found with respect to Survey 2.

The reports generated by a reporting application (such as reporting application 34 in FIG. 1) may include the comparative risk values for each of the pathogens of interest, or for only those pathogens of concern to or selected by the particular corporate entity or restaurant. In addition, the reports may also include the frequency of occurrence, the severity of occurrence, and/or the difficulty of detection, either alone or in combination with each other.

The results shown in the reports may be used to identify areas where the corporate entities and/or restaurants need improvement in order to reduce the risk of foodborne illness outbreaks. The reports may also be used to identify trends over time as to the comparative risks of food borne illness outbreaks. The reports may further indicate whether employee training with respect to certain food preparation, cleaning, hand washing, or personal hygiene practices may help to reduce the likelihood of foodborne illness outbreaks. The reports may indicate or recommend use of certain food preparation, cleaning, hand washing, or personal hygiene products or other type of procedure or product that may help to reduce the risk of foodborne illness outbreaks.

In another example, inspection data from outbreak restaurants may be compared with inspection data from non-outbreak restaurants to determine whether any violations are recorded more frequently in outbreak restaurants than in non-outbreak restaurants. For example, such an analysis may be used to determine whether violations of any of a standardized set of survey questions (such as the 54 questions presented in the model “Food Establishment Inspection Report” discussed above) are recorded more frequently in outbreak restaurants than in non-outbreak restaurants. Such an analysis may arrive upon a subset (i.e., one or more) of the standardized set of survey questions in which violations are recorded more frequently in outbreak restaurants than in non-outbreak restaurants. This subset may be referred to as a set of one or more “indicative violations.” The one or more indicative violations may be statistically more likely to be associated with establishments that experienced outbreaks than with those that did not experience an outbreak, as more fully described below.

The one or more indicative violations may be used to generate an “outbreak profile continuum.” The outbreak profile continuum may relate a number of indicative violations experienced by a hypothetical restaurant with the degree to which that hypothetical restaurant looks like, or fits the profile of, an outbreak restaurant.

Actual inspection data for a particular restaurant may then be used to place the restaurant along the outbreak profile continuum. This may help identify the degree to which the restaurant “looks like,” or fits the profile of, and outbreak restaurant. This information may assist with identifying locations that resemble outbreak locations and may also help to direct proactive preventative resources in a direction where they may benefit the particular food safety practices underlying the particular indicative violations experienced by the restaurant location.

To determine the set of indicative violations, inspection data from a plurality of restaurants that experienced outbreaks (outbreak locations) and inspection data from a plurality of restaurants that did not experience outbreaks (non-outbreak locations) may be compared to identify a set of one or more indicative violations that are recorded more frequently in outbreak locations than in non-outbreak locations.

In one example, 75 routine inspections were obtained from the Minnesota Department of Health for Minnesota chain restaurants involved in known outbreaks that occurred from 2005-2010. Forty-four norovirus outbreaks, thirteen Salmonella, and eleven Clostridium perfringens or toxin-mediated outbreaks were included in the total sample set. 172 routine inspections collected from 91 different chain restaurants were also obtained for Minnesota restaurants that were not involved in known outbreaks from 2008-2011. Violations from these routine inspections at outbreak and non-outbreak locations were mapped to FDA Food Code Form 3-A as described above.

Initially, comparison was done between all routine inspections done at outbreak and non-outbreak locations. Recorded occurrences of violations from FDA Food Code Form 3-A were compared in 2-proportion tests and 95% significances were determined.

Because relatively few outbreaks occurred in this example, a final analysis combined the individually calculated relative risks for all outbreak types together to develop an overall profile of the likelihood of any of these types of outbreaks via Meta-analysis relative risk calculations using StatsDirect (StatsDirect Ltd., Cheshire, UK Software Version 2.7.8). The subset of survey questions chosen as a result of this analysis in this example were those whose lower confidence interval limits were greater than one and whose upper limits were less than infinity. In this example, there were several survey questions with large risk ratios that were not included in this list because their upper confidence limits were infinity.

Table 9 lists the 13 violation types significantly more likely to be recorded (α<0.05) in routine inspections done outbreak chain locations (n=75) than in non-outbreak chain locations (n=172) as found in this example.

TABLE 9
Two-Proportion tests of violations significantly more likely to be
recorded in routine inspections at chain outbreak locations (n = 75)
compared to chain non-outbreak locations (n = 172).

| Violation | | |
|---|---|---|
| Number | | |
| from Form | | |
| 3-A | Violation type | p-value |
| 4 | Proper eating, tasting, tobacco use | 0.015831 |
| 7 | No bare hand contact with food or use of | 0.012444 |
| | approved alternate procedure | |
| 17 | Proper re-heating for hot holding | 0.031526 |
| 18 | Proper cooling time & temperature | 0.004283 |
| 20 | Proper cold holding temperatures | 0.010912 |
| 21 | Proper date marking & disposition | 0.024866 |
| 31 | Proper cooling methods used; adequate equipment | 0.001742 |
| | for temp control | |
| 35 | Food Properly labeled; original container | 0.000131 |
| 37 | Contamination prevented during food prep, | 0.008542 |
| | storage, & display | |
| 42 | Utensils, equipment & linens properly stored, | 0.001963 |
| | dried, handled | |
| 43 | Single use/Single service articles; properly | 1.36E−06 |
| | stored & used | |
| 47 | Non food contact surfaces clean | 1.3E−06 |
| 54 | Adequate ventilation & lighting | 0.020778 |

To evaluate the inspection data further, additional calculations may be done. In this example, relative risks of the likelihood of each violation occurring at an outbreak chain location as compared at a non-outbreak chain location were calculated. Generally, in this example, a Relative Risk>1 indicates that an association exists and a Relative Risk>5 means a relatively strong to strong association exists.

Meta-analysis resulted in development of a subset of violation types relatively more likely to be associated with outbreak restaurants in general. In this example, focus was on those violations which were more likely to be observed in outbreak restaurants whose confidence intervals in the overall analysis were greater than one and less than infinity. This resulted in identification of 11 indicative violations shown in Table 10. These are the one or more indicative violations that were statistically more likely to be associated with establishments that experienced outbreaks than with those that did not experience an outbreak in this example. The list of indicative violations shown in the example of Table 11 is not specific to any of the three individual agents.

In order to check the validity of these identified core violations in this example, sensitivity analysis was done by systematically changing the occurrence of violations to determine the effects of such changes on p-values. In this example, the only violations that remained in the set were those whose p-values remained at ≦0.05 under 5 different scenarios—the actual data; outbreak restaurant violation occurrence plus and minus one; and non-outbreak restaurant violation occurrence plus and minus one.

TABLE 10
Relative Risks of Specific Violations More likely to be observed in Routine
Inspections at an Outbreak Restaurant

| | | | | Failure | |
|---|---|---|---|---|---|
| | | | | Frequency in | Failure Frequency |
| Violation | | | | Outbreak | in Non Outbreak |
| Number from | | | | restaurants | restaurants |
| Form 3-A | Violation type | RR | 95% CI | (n = 75) | (n = 172) |
| 4 | Proper eating, tasting, | 4.59 | 1.28-16.36 | 0.08 | 0.01 |
| | tobacco use | | | | |
| 7 | No bare hand contact | 2.8 | 1.23-6.32 | 0.15 | 0.05 |
| | with food or use of | | | | |
| | approved alternate | | | | |
| | procedure | | | | |
| 18 | Proper cooling time & | 11.47 | 1.81-73.27 | 0.06 | 0.006 |
| | temperature | | | | |
| 20 | Proper cold holding | 1.83 | 1.15-2.89 | 0.32 | 0.17 |
| | temperatures | | | | |
| 31 | Proper cooling methods | 5.16 | 1.73-15.37 | 0.12 | 0.02 |
| | used; adequate | | | | |
| | equipment for temp | | | | |
| | control | | | | |
| 35 | Food Properly labeled; | 3.53 | 1.87-6.64 | 0.18 | 0.14 |
| | original container | | | | |
| 37 | Contamination | 2.01 | 1.19-3.34 | 0.28 | 0.14 |
| | prevented during food | | | | |
| | prep, storage, & display | | | | |
| 42 | Utensils, equipment & | 2.41 | 1.37-4.21 | 0.27 | 0.11 |
| | linens properly stored, | | | | |
| | dried, handled | | | | |
| 43 | Single use/Single | 10.7 | 3.40-33.98 | 0.19 | 0.02 |
| | service articles; | | | | |
| | properly stored & used | | | | |
| 47 | Non food contact | 3.38 | 2.03-5.63 | 0.37 | 0.11 |
| | surfaces clean | | | | |
| 54 | Adequate ventilation & | 1.72 | 1.09-2.68 | 0.32 | 0.19 |
| | lighting | | | | |

Since it is not known before an outbreak which agent may cause it, knowledge of the overall risk of the top three types of outbreaks (norovirus, Salmonella, and C. perfringens/toxin-type) may permit identification of appropriately targeted interventions to prevent such an outbreak. Further, because the CDC has reported that these three agents caused approximately 75% of confirmed and suspected foodborne illness outbreaks in 2008, knowledge of factors that may affect outbreaks attributed to these agents could have a significant impact on overall illness incidence. However, it shall be understood that a similar analysis may be done on an agent-by agent basis, if desired.

The indicative violations may be categorized with respect to the CDC contributing factors to foodborne illness (described above). In this example, about two-thirds of the indicative violations more likely to be observed in outbreak locations fall into the “Contamination” category, e.g., of hands, surfaces, food. The remaining violations in this example are associated with the “Proliferation” or growth as they are associated with temperature-related concerns that may occur during preparation or storage.

In the example analysis described above, health inspection data from Minnesota restaurants obtained during particular time periods were used to identify one or more indicative violations that were more likely to be associated with outbreak restaurants than with non-outbreak restaurants. However, it shall be understood that health inspection data used to identify the one or more indicative violations need not be limited to a particular state or other geographic region, or to particular time periods.

For example, an analysis of health inspection data from Arizona restaurants experiencing outbreaks and Arizona restaurants that did not experience restaurants resulted in the following set of indicative violations:

TABLE 11
Indicative violations from Arizona example data sets

| Violation Number | |
|---|---|
| from Form 3-A | Violation type |
| 13 | Food separated/protected |
| 34 | Thermometers provided and |
| | accurate |
| 37 | Contamination prevented during |
| | food prep, storage, & display |
| 42 | Utensils, equipment & linens |
| | properly stored, dried, handled |
| 53 | Physical facilities installed, |
| | maintained & clean |

In addition, the particular types of statistical analysis described herein with respect to the example is not intended to limit the disclosure, but rather to provide an example of how such analysis may be performed. Those of skill in the art will readily understand that many other statistical methods may be used to analyze health inspection data, and/or to arrive at a set of one or more indicative violations.

Also, the resultant indicative violations may depend at least in part upon the particular data sets chosen for the analysis. Therefore, the indicative violations need not necessarily include all or even some of the indicative violations listed in any of Tables 9, 10, or 11.

In this example, the relative risk for each of the individual indicative violations shown in Table 10 was calculated by dividing the failure rate per question for outbreak restaurants by the failure rate per question for non-outbreak restaurants.

The overall relative risk for a hypothetical restaurant based on the total number of indicative violations experienced (e.g., the total number of indicative violation survey questions failed) may also be calculated.

$$Relative Risk = \frac{Failure Rate Per Question ( Outbreak Restaurants )}{Failure Rate per Question ( Non \text{-} Outbreak Restaurants )}$$

$$where$$

$$Failure Rate Per Question = \frac{Total Number of Failures}{\begin{matrix}Total Number of Opportunities \\ to fail any one of the questions\end{matrix}}$$

In this example, for restaurants involved in outbreaks, there were 825 opportunities to fail any one of the 11 questions (75 inspections from known outbreak locations×11 indicative violations=825). Out of 825 opportunities, there were 182 failures. The average number of failures per inspection was 2.427 (182/75=2.427). The failure rate per question was 0.221 (182/825=0.221=2.427/11).

For restaurants not involved in outbreaks, there were 1892 opportunities to fail any one of the 11 questions (172 inspections from non-outbreak locations×11=1892). Out of 1892 opportunities, there were 157 failures. The average number of failures per inspection was 0.913 (157/172=0.913). The failure rate per question was 0.082 (172/1892=0.082=0.913/11).

The calculation for relative risk in this example may then be expressed as follows:

$$\frac{\frac{182}{825}}{\frac{157}{1892}} \times \frac{\frac{1 / 75}{1 / 75}}{\frac{1 / 172}{1 / 172}} = \frac{\frac{2.427}{11}}{\frac{0.913}{11}} = \frac{2.427}{0.913} = 2.658$$

As mentioned above, the relative risks for the subset of indicative violations more likely to be observed at an outbreak versus a non-outbreak location may help to characterize the likelihood of a violation occurring at an outbreak location versus a non-outbreak location. The relative risk value may be used to generate a table associating a number of indicative violations with a relative risk, such as that shown in Table 12:

TABLE 12

| Number of Indicative Violations | Relative Risk |
|---|---|
| 2.658 | 2.658 (2.427/0.913) |
| 3 | 3.29 (3/0.913) |
| 4 | 4.38 (4/0.913) |
| 5 | 5.48 (5/0.913) |
| Etc. | |

The relative risk in column 2 of Table 12 was determined by dividing a hypothetical number of indicative violations (e.g., 3, 4, 5, . . . ) by the failure rate per question for non-outbreak restaurants (in this example. 0.913). However, depending upon the results of the inspection data, the relative risk may be higher or lower for the total number of indicative violations.

As mentioned above, the one or more indicative violations may be used to generate an “outbreak profile continuum.” The outbreak profile continuum may relate a number of indicative violations experienced by a hypothetical restaurant with the degree to which that hypothetical restaurant looks like, or fits the profile of, an outbreak restaurant.

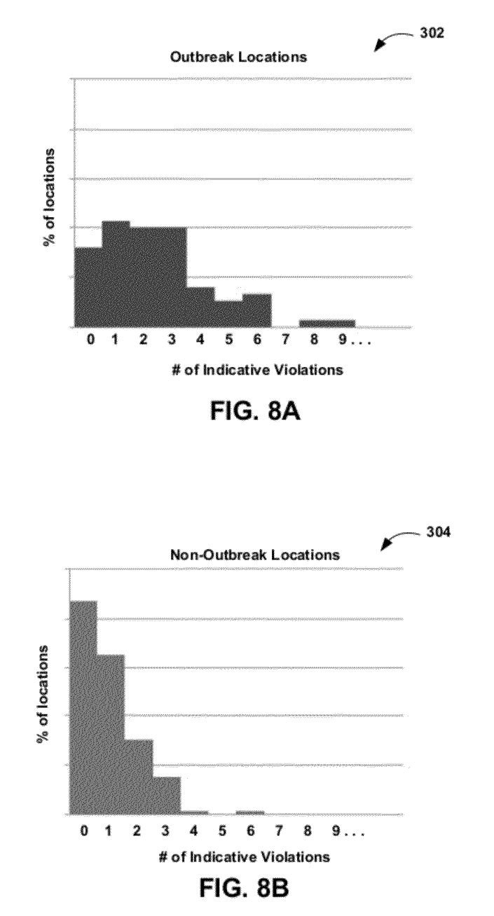

FIGS. 8A and 8B are graphs illustrating the distribution of the percent of restaurant locations having a given number of indicative violations. FIG. 8A shows a graph 302 illustrates the distribution for outbreak restaurants and FIG. 8B shows a graph 304 illustrating the distribution for non-outbreak restaurants. A comparison of FIG. 8A versus FIG. 8B illustrates that the outbreak locations had a relatively higher percentage of locations that received a higher number of indicative violations.

The information from FIGS. 8A and 8B may be used to generate an outbreak profile continuum. In the outbreak profile continuum, a relatively lower rating on the continuum may be associated with few or no indicative violations, and a higher rating on the continuum may be associated with a relatively higher number of failures on the indicative violations. An example outbreak profile continuum is shown in Table 13.

TABLE 13
Example Outbreak Profile Continuum

| | # of Indicative | |
|---|---|---|
| Rating | Violation Failures | Continuum |
| Red | 6 or more | Looks relatively more |
| | | like an outbreak |
| | | restaurant |
| Orange | 3-5 | ↑ |
| Yellow | 1-2 | ↓ |
| Yellow-Green | 0 | No failures on indicative |
| | | violations |

In this example, data from FIGS. 8A and 8B were used to draw reasoned conclusions as to the number of indicative violations that should be associated with each rating on the continuum. In this example, because the data of FIG. 8A indicated that relatively more outbreak locations than non-outbreak locations experienced 6 or more indicative violations, the highest, or “red” rating on the continuum was associated with 6 or more violations and thus with a higher resulting level on the continuum.

Actual inspection data for a particular restaurant may then be used to place the restaurant along the outbreak profile continuum. This may help identify the degree to which a particular restaurant “looks like,” or fits the profile of, and outbreak restaurant based on its inspection data. This information may assist with identifying locations that resemble outbreak locations and may also help to direct proactive preventative resources in a direction where they may benefit the particular food safety practices underlying the particular indicative violations experienced by the restaurant location.

For example, if inspection data from a particular restaurant (Restaurant A) indicated that the restaurant experienced 2 indicative violations, that restaurant would fall on the “Yellow” rating of the outbreak profile continuum. If inspection data from another restaurant (Restaurant B) indicated that it experienced 7 indicative violations, that restaurant would fall on the “Red” rating of the outbreak profile continuum. This might indicate that Restaurant B fit the profile of an outbreak restaurant than did Restaurant A.

Although the information from the outbreak profile continuum is not necessarily predicative of whether a restaurant will experience or not experience an outbreak, the information may be of value by indicating how closely a particular restaurant matches the profile of an outbreak restaurant, and therefore may help indicate whether corrective measures should be taken.

This example described herein suggests that attention to specific types of violations may permit identification of a “profile” for those restaurants exhibiting characteristics of restaurants that experienced foodborne illness outbreaks; namely, the number of indicative violation failures may be used to place a restaurant location along a risk zone continuum that associates a number of indicative violation failures with a relative indication of how closely the restaurant's inspection data resembles a so-called outbreak restaurant. These results from restaurant inspections may be used to provide feedback to the operator on the effectiveness of the establishment's process controls and may help to enable focus on interventions and programs where they may have the greatest impact on the occurrence of foodborne illness outbreak.

A reporting application (such as reporting application 34 in FIG. 1) may generate reports including the relative risk values for each of the pathogens of interest, or for only those pathogens of concern to or selected by the particular corporate entity or restaurant. In addition, the reports may also include the location's risk zone rating and/or position on a risk zone continuum, either alone or in combination with each other.

The results shown in the reports may be used to identify areas where the corporate entities and/or restaurants need improvement in order to reduce the risk of foodborne illness outbreaks. The reports may also be used to identify trends over time as to the comparative results from health department inspection data over time. The reports may further indicate whether employee training with respect to certain food preparation, cleaning, hand washing, or personal hygiene practices related to any one or more of the indicative violations may help to reduce the likelihood of foodborne illness outbreaks. The reports may indicate or recommend use of certain food preparation, cleaning, hand washing, or personal hygiene products or other type of procedure or product that are directed to addressing the failures indicated by the associated indicative violations.

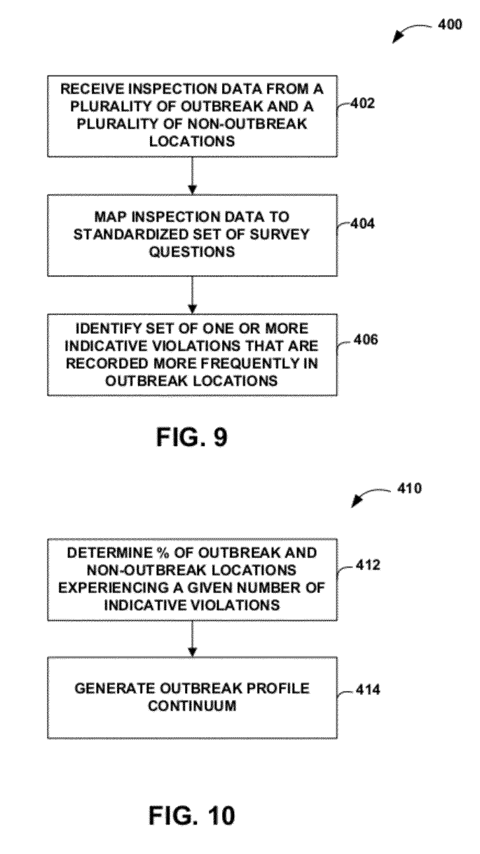

FIG. 9 is a flowchart illustrating an example process 400 by which a set of one or more indicative violations may be determined. One or more processors or server computers, such as server computer 30 shown in FIG. 1, may execute a software program containing instructions for performing example process 400. For example, such as program may be part of indicative violation module 52 as shown in FIG. 1.

The processor may receive inspection data from a plurality of outbreak locations (e.g., restaurants that experienced one or more outbreaks) and inspection data from a plurality of non-outbreak locations (e.g., restaurants that did not experience any outbreaks) (402). The processor may map the inspection data from the outbreak and the non-outbreak locations to a standardized set of survey questions (404). The process may then identify a set of one or more indicative violations that are recorded more frequently in outbreak locations than in non-outbreak locations (406).

FIG. 10 is a flowchart illustrating an example process 410 by which an outbreak profile continuum may be generated. One or more processors or server computers, such as server computer 30 shown in FIG. 1, may execute a software program containing instructions for performing example process 410. For example, such as program may be part of indicative violation module 52 as shown in FIG. 1.

The processor may determine the percentage of outbreak and non-outbreak locations experiencing a given number of indicative violations (412). The processor may then generate an outbreak profile continuum based on the determined percentages (414). Example step (414) may also be performed manually by one or more persons through interpretation of the percentage of outbreak and non-outbreak locations experiencing a given number of indicative violations determined in step (412).

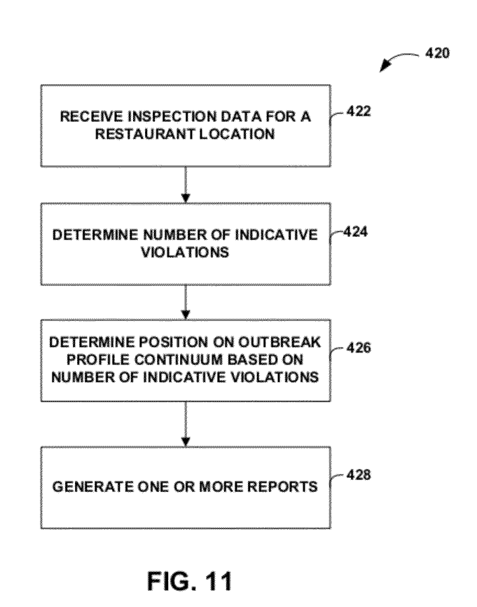

FIG. 11 is a flowchart illustrating a process 420 by which a restaurant's position on an outbreak profile continuum may be determined. One or more processors or server computers, such as server computer 30 shown in FIG. 1, may execute a software program containing instructions for performing example process 420. For example, such as program may be part of indicative violation module 52 as shown in FIG. 1.

The processor may receive inspection data for a restaurant location (422). The processor may determine the number of indicative violations experienced by the restaurant based on the inspection data (424). The processor may determine a position on an outbreak profile continuum based on the number of indicative violations (426). The processor may also generate one or more reports based on, for example, the inspection data, the determined number of indicative violations, and/or the restaurant's relative position on the outbreak profile continuum (428).

In some examples, the systems, methods, and/or techniques described herein may encompass one or more computer-readable media comprising instructions that cause a processor, such as processor(s) 202, to carry out the techniques described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, a optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel. Computer-readable media may be described as “non-transitory” when configured to store data in a physical, tangible element, as opposed to a transient communication medium. Thus, non-transitory computer-readable media should be understood to include media similar to the tangible media described above, as opposed to carrier waves or data transmitted over a transmission line or wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The systems and/or methods described herein may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above. A processor for executing such instructions may be implemented in hardware, e.g., as one or more hardware based central processing units or other logic circuitry as described above.

Various examples have been described. These and other examples are within the scope of the following claims.

1. A method comprising:
receiving inspection data from a plurality of restaurants that each experienced at least one associated foodborne illness outbreak;
receiving inspection data from a plurality of restaurants that did not experience any foodborne illness outbreaks;
mapping the inspection data from the plurality of restaurants that each experienced an associated foodborne illness outbreak to a standardized set of survey questions;
mapping the inspection data from the plurality of restaurants that did not experience any foodborne illness outbreaks to the standardized set of survey questions; and
identifying a set of one or more indicative violations from among the standardized set of survey questions that were recorded more frequently in the restaurants that experienced at least one associated foodborne illness outbreak than in the restaurants that did not experience any foodborne illness outbreaks.

2. The method of claim 1 wherein receiving inspection data further comprises receiving at least one of one of a routine inspection report, a follow-up inspection report, or an investigational inspection report.

3. The method of claim 1 wherein receiving inspection data from a plurality of restaurants that each experienced at least one associated foodborne illness outbreak further comprises receiving inspection data from a plurality of restaurants that each experienced at least one of a Salmonella, a C. perfringens, or a norovirus outbreak.

4. The method of claim 1 wherein identifying a set of one or more indicative violations comprises determining a relative risk for each of the standardized set of survey questions based a failure rate per question for the plurality of restaurants that each experienced at least one associated foodborne illness outbreak by a failure rate per question for the plurality of restaurants that did not experience any foodborne illness outbreaks.

5. The method of claim 4 further comprising identifying the set of one or more indicative violations based on the relative risk for each of the standardized set of survey questions.

6. The method of claim 1 wherein identifying a set of one or more indicative violations further includes identifying a set of one or more indicative violations from among the standardized set of survey questions that are statistically more likely to be observed in the restaurants that experienced at least one associated foodborne illness outbreak than in the restaurants that did not experience any foodborne illness outbreaks.

7. The method of claim 1 further comprising generating a report that includes the set of one or more indicative violations.

8. The method of claim 1 further comprising generating a report recommending at least one of a training procedure, a food preparation product, a cleaning product, a hand washing product, or a personal hygiene product based on the indicative violations.

9. The method of claim 1 wherein identifying a set of one or more indicative violations comprises identifying at least one of the standardized set of survey questions related to a contamination factor, a proliferation factors, or a survival factor.

10. The method of claim 1 wherein identifying a set of one or more indicative violations comprises comparing inspection data from the plurality of restaurants that each experienced at least one associated foodborne illness outbreak with the inspection data from the plurality of restaurants that did not experience any foodborne illness outbreaks.

11. The method of claim 1 wherein identifying a set of one or more indicative violations comprises using a 2-proportion z-test to compare inspection data from the plurality of restaurants that each experienced at least one associated foodborne illness outbreak with the inspection data from the plurality of restaurants that did not experience any foodborne illness outbreaks.

12. The method of claim 1 wherein identifying a set of one or more indicative violations comprises a 95% confidence interval for each of the standardized set of survey questions to compare inspection data from the plurality of restaurants that each experienced at least one associated foodborne illness outbreak with the inspection data from the plurality of restaurants that did not experience any foodborne illness outbreaks.

13. The method of claim 1 further comprising calculating an overall relative risk by dividing a number of indicative violations experienced by a hypothetical restaurant by the failure rate per question for the plurality of restaurants that did not experience any foodborne illness outbreaks.

14. The method of claim 13 further comprising:
associating a higher overall relative risk with a higher number of indicative violations experienced by a hypothetical restaurant; and
associating a lower overall relative risk with a lower number of indicative violations experienced by a hypothetical restaurant.

15. A system comprising:
a database that stores inspection data from a plurality of restaurants that each experienced at least one associated foodborne illness outbreak and that stores inspection data from a plurality of restaurants that did not experience any foodborne illness outbreaks;
a mapping that relates the inspection data from the plurality of restaurants that each experienced an associated foodborne illness outbreak to a standardized set of survey questions and that relates the inspection data from the plurality of restaurants that did not experience any foodborne illness outbreaks to the standardized set of survey questions; and
at least one processor that identifies a set of one or more indicative violations from among the standardized set of survey questions that were recorded more frequently in the restaurants that experienced at least one associated foodborne illness outbreak than in the restaurants that did not experience any foodborne illness outbreaks.

16. The system of claim 15 wherein the inspection data comprises at least one of one of a routine inspection report, a follow-up inspection report, or an investigational inspection report.

17. The system of claim 15 wherein the at least one associated foodborne illness outbreak experienced comprises at least one of a Salmonella, a C. perfringens, or a norovirus outbreak.

18. The system of claim 15 wherein the at least one processor further generates a report recommending at least one of a training procedure, a food preparation product, a cleaning product, a hand washing product, or a personal hygiene product based on the indicative violations.

19. The system of claim 15 wherein the processor further identifies the set of one or more indicative violations by identifying at least one of the standardized set of survey questions related to a contamination factor, a proliferation factors, or a survival factor.

20. The system of claim 15 wherein the processor further determines a relative risk for each of the standardized set of survey questions based a failure rate per question for the plurality of restaurants that each experienced at least one associated foodborne illness outbreak by a failure rate per question for the plurality of restaurants that did not experience any foodborne illness outbreaks.
